(19) United States
(12) Patent Application Publication
(10) Pub. No.: US 2015/0165329 A1
(43) Pub. Date: Jun. 18, 2015

(54) SYSTEM AND METHOD FOR CONNECTING USERS BASED ON COMMON INTERESTS, SUCH AS SHARED INTERESTS OF REPRESENTATIONS OF PROFESSIONAL ATHLETES

(71) Applicants: Michael J. SMITH, Seattle, WA (US); Christopher L. ANDERSON, Seattle, WA (US); Zoltan SZABADI, Seattle, WA (US)

(72) Inventors: Michael J. SMITH, Seattle, WA (US); Christopher L. ANDERSON, Seattle, WA (US); Zoltan SZABADI, Seattle, WA (US)

(21) Appl. No.: 14/568,383

(22) Filed: Dec. 12, 2014

Related U.S. Application Data
(63) Continuation of application No. 12/099,132, filed on Apr. 7, 2008, now abandoned.
(60) Provisional application No. 60/910,620, filed on Apr. 6, 2007.

(51) Int. Cl. A63F 13/795; A63F 13/828

(52) U.S. Cl. CPC A63F 13/795; A63F 13/828

(57) ABSTRACT

A system and method for connecting users based on common participation, ownership, or interest in a commodity or market, such as common ownership of a player associated with fantasy sports, is described. In some cases, the system presents a page associated with the commonly-interesting player to a user. In some cases, the provided content includes comments provided by other users or content provided by sources other than a source hosting a fantasy sports league associated with the player.

### CROSS REFERENCE TO RELATED APPLICATIONS

This application claims priority to U.S. Provisional Patent Application No. 60/910,620, filed on Apr. 6, 2007, entitled SYSTEM AND METHOD OF CONNECTING USERS BASED ON SHARED POSSESSIONS, SUCH AS SHARED REPRESENTATIONS OF PROFESSIONAL ATHLETES, which is incorporated by reference in its entirety.

### BACKGROUND

Fantasy and/or Rotisserie Sports enable users to play games based on real-life outcomes of professional and other sports. A user may build a team associated with real-life players in a certain sport and compete against other users to earn points or wins based on the statistics generated by the real-life players when they play their sport. Popular fantasy sports include fantasy football, fantasy baseball, fantasy basketball, and so on.

Generally, a fantasy league is formed of two or more users (i.e., owners, managers, and so on), that select or draft representations of real-life players to build competing teams. Often, there is no common ownership of players within the league (that is, only one manager owns any specific player at any given time). The teams then compete against one another based on outcomes within an associated sport and according to specified rules and scoring methods. For example, a football fantasy league may match one fantasy team against another for every week of a football season, tracking real-life player performances to determine the winner for the week. In contrast, a baseball fantasy league may track the cumulative hitting and/or pitching statistics of real-life players, and determine a winner based on the cumulative statistics. Of course, there are many other game and scoring formats associated with fantasy sports.

Because of the popularity of fantasy sports, many sports content sites (e.g, espn.com, cnnsi.com, cbssportsline.com, and so on) host and/or support fantasy sports leagues. At these sites, a user may join a league with other anonymous users or create a league with known users in order to play. These sites may offer various services (often unique to their site) in order to attract as many users as possible, leading to many users entering leagues at more than one fantasy sports site.

However, as fantasy sports grow in popularity, so do problems associated with providing fantasy sports leagues to users. In addition to the sites running and hosting leagues, there are many auxiliary and/or complementary sites providing fantasy sports related information to users (such as scouting information about players), leading to an abundance of information that may be unreliable, misleading, or confusing to a user.

These and other problems exist with respect to providing fantasy sports games and entertainment to users.

### BRIEF DESCRIPTION OF THE DRAWINGS

FIG. 1 is a block diagram illustrating a suitable computing environment.

FIG. 2 is a block diagram illustrating a suitable networked environment.

FIG. 3 is a display illustrating an example user management page presented by an intermediate site.

FIG. 4 is a flow diagram illustrating a routine for updating a user's fantasy sports team.

FIG. 5 is a flow diagram illustrating a routine for generating a player page associated with a representation of a player within a fantasy sports league.

FIG. 6 is a display illustrating an example player page in a fantasy sports environment.

FIG. 7 is a flow diagram illustrating a routine for displaying content about a good or service to a user.

### DETAILED DESCRIPTION

A system and method for connecting users sharing an interest in researching or owning a commodity is disclosed. The shared commodity may be a virtual asset or commonly owned asset, an owned commodity, a rented or shared commodity, a representation of a commodity (such as a representation of an athlete or player of a sport), purchased product, and so on.

In some examples, the system provides a user with access to information related to a player the user is interested in learning more information about or possibly obtaining for one or more of his/her fantasy sports teams. The system may receive information in the form of comments, remarks, performance prognostications, and so on, from other users of the system, and present this information to the user in a variety of ways. For example, the system may provide the user with other user's comments about the commodity, other user's contact information (such as email addresses or instant messaging addresses), dedicated message boards, and so on.

For example, a fantasy sports website, such as an intermediate or league aggregation website described herein, may connect users through a player in whom they share a common interest, through a player commonly owned by the users, and so on. The system may present and manage a page associated with the player that presents comments from users, such as users who own the player in their respective leagues, users interested in obtaining the player, and so on. The player page may present similar elements to all users across the system, or may present specific elements to certain users (that is, the system may present a user or a subset of users a page for the shared player based on the user's preferences or input).

Shared or unique elements presented by the system may include player statistics (which may be modified based on parameters of the league in which the user owns the player), a photo or other video or audio representations of the player (such as a multimedia presentation of the player depicting the player in a real-life game), sponsored links or other advertisements (which may be based on or associated with the player or other elements of the system), statistics and points relevant to the user's league (e.g., the player's cumulative fantasy points), comments from other users that own the player in their respective leagues, comments from select users, links to additional information about the player, users that provide comments, and so on.

Thus, when a user of the system accesses one of his/her leagues, the system may present a list of players owned by the user in that league. Upon selecting a player, the system may present some or all aspects of the shared player page described herein. The system may also facilitate connections between the user and other users in other leagues that own the player or indicate an interest in discussing the player or receiving additional information about the player. The system, therefore, may provide a social network of fantasy sports users via players owned by or of interest to the users, among other benefits.

In some examples, the system facilitates user management of an owned or managed team in a fantasy league without requiring the user to directly access the league via a league provider's site. In some cases, the system (via an site hosting the system) may receive a message (such as a text message, a short message service message, a USSD message, an instant message, and so on), extract some or all of the contents of the message, and cause the site managing the fantasy league to perform an action for the user. In some cases, the message is received by an intermediate site, such as a site associated with a user that provides a single access point to multiples leagues contained at different game sites. Thus, in some cases the system enables users to access, manage, and control their fantasy teams without having to access the site or sites supporting the leagues that contain the user's fantasy teams. The intermediate site, therefore, can offer a user an enhanced and flexible fantasy sports experience regardless of what site hosts the user's leagues, among other benefits.

The following description provides specific details for a thorough understanding of, and enabling description for, various embodiments of the technology. One skilled in the art will understand that the technology may be practiced without these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

### Suitable System

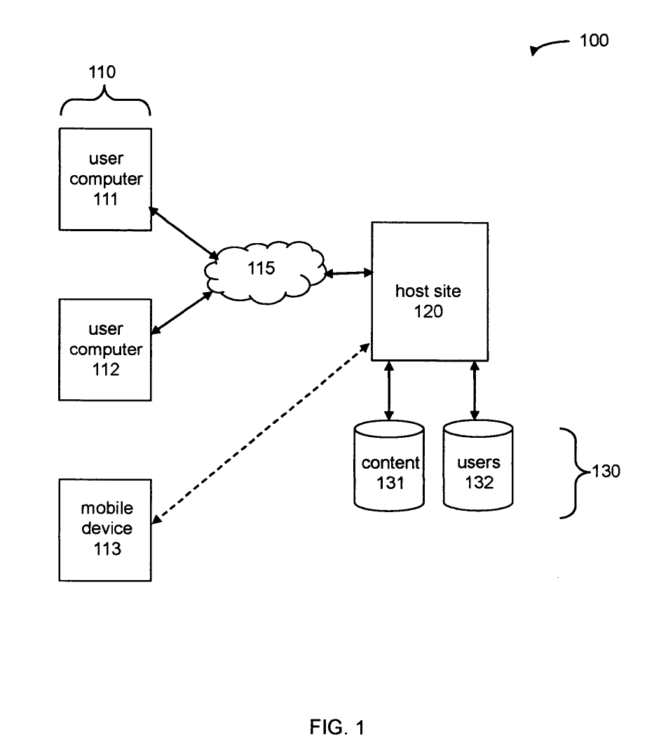

As described herein, the system may be provided by a fantasy sports management site, or an intermediate site that facilitates user access to one or more fantasy sports sites via a single access point. FIG. 1 provides a block diagram illustrating a suitable computing environment in which the system can be implemented. Although not required, aspects of the system are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a personal computer or mobile device, and thus, while certain hardware platforms are described herein, aspects of the system are equally applicable to nodes on a network. In an alternative embodiment, the personal computer or mobile device may represent the server portion, while the server may represent the client portion.

Referring to FIG. 1, the system may be implemented in a computing environment 100 that includes one or more user computers 110 (such as user computer 111 and user computer 112) that communicate with a fantasy sports site 120 via a network 115, such as the Internet. In some cases, the fantasy sports site 120 may also communicate with a user via a user's mobile device 113, such as a cell phone. The user computers 110 and fantasy sports site 120 may include processors, network connection components, input devices, output devices, display devices, storage components, and so on. The fantasy sports site may be, for example, a server computer that communicates with one or more databases 130, such as a content database 131 that stores content associated with players or a user database 132 that stores information about users of leagues supported by the fantasy sports site, in order to display information to users related to leagues, teams, representations of players, content associated with players, and other information relevant to and associated with the user and/or the user's owned teams and players.

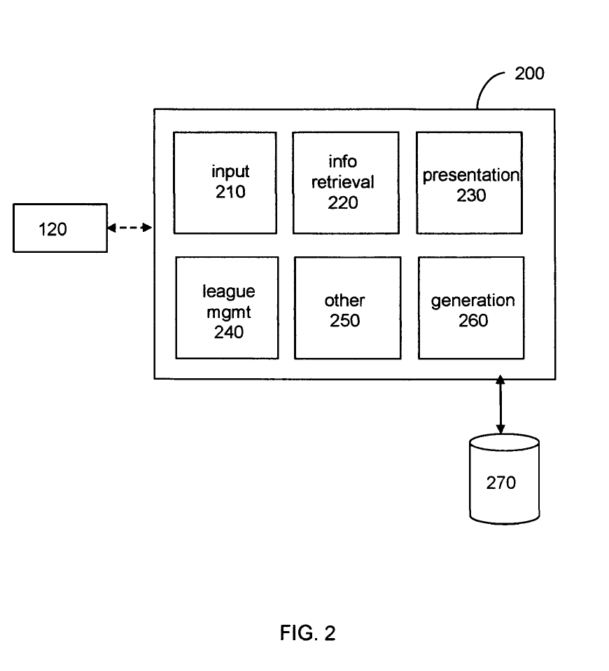

Referring to FIG. 2, a block diagram illustrating components of an intermediate fantasy sports management site 200 is shown. The intermediate site 200 may include an input component 210 that receives input from users. Input may include requests from users via user selectable elements presented to a user via a management page, to be discussed in greater detail herein, or may include other inputs, such as messages received from users via mobile devices. The intermediate site 200 may also include an information retrieval component 220 that retrieves information (such as content about a player owned by the user), a generation component 260 that generates visual, audio and other multimedia elements (such as pages or elements on a webpage) to be presented to the user via display device associated with the user, and a presentation component 230 that presents the generated pages and elements to the user via the associated display device.

The intermediate site 200 may also include a league management component 240 that facilitates the management of user owned teams via the intermediate site. For example, the league management component 240 may receive instructions from the input component 210 indicating a user request to update a team within a league hosted by the fantasy sports site 120, may access the league at the fantasy sports site 120 on behalf of the user (such as by supplying access credentials associated with the user), and perform the necessary actions to update the team according to the request received from the user.

In addition, in some cases the intermediate site 200 may include other components 250, such as components that access sites providing content about players, sports, and so on, components that receive messages from uses originating from user mobile devices, components that determine user requests from received messages, components that provide security for content stored on the site, such as user credentials, user billing information, user preferences, and so on.

The intermediate site 200 may communicate with or include one or more databases 270 that store or contain user information, content (such as content associated with players, content provided or created by users, content received from other sources, and so on), league parameter information, real-life player information (such as player statistics), relational data structures that associate users, content, and players and other commonly owned/managed entities, and so on. For example, the intermediate site may access the database 270 to retrieve information and content associated with a player in order to generate a player page via the generation component 260 for the player.

Of course, one of ordinary skill in the art will appreciate that the system may provide components 210-260 within a fantasy sports provider, such as fantasy sports site 120, or other sites that support and facilitate game play related to fantasy sports.

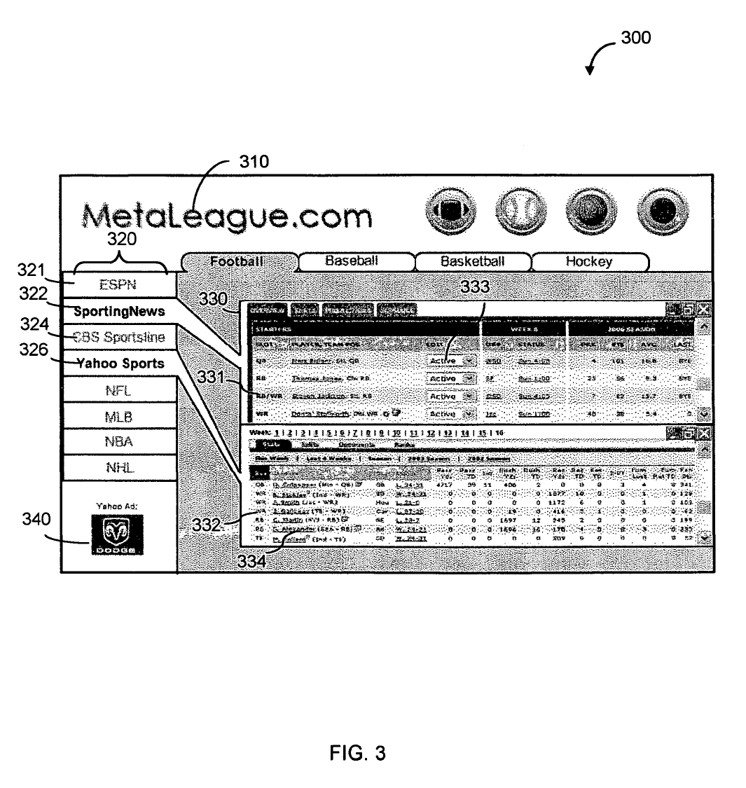

In some examples, the system, via the intermediate site 200, may provide users with a display page that facilitates interactions between the user and the user's respective leagues, such as by presenting content related to players owned by, managed by, or of interest to a user, or by connecting users that commonly own or share interest in a player in their respective leagues, and so on. FIG. 3 is a display illustrating an example user management page 300 presented by the intermediate site 200. FIG. 3 (and other screen displays described herein), representative phone or computer displays, or web pages, are shown for performing certain tasks described herein. The screens provide facilities to receive input data, such as a form with field(s) to be filled in, menu selections, pull-down menus or entries allowing one or more of several options to be selected, buttons, sliders, hypertext links or other known user interface tools for receiving user input. While certain ways of displaying information to users is shown and described with respect to certain Figures, those skilled in the relevant art will recognize that various other alternatives may be employed. The terms “screen,” “web page,” and “page” are generally used interchangeably herein.

The screens may be stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), Flash format, or matrix or bit-mapped formats.

Referring to FIG. 3, the page 300 includes header and other information 310 that provides identification information about the intermediate site 200 (e.g., “metaleague.com”), navigation buttons or elements 312 that facilitate navigation between sports supported by the site 310, and navigation tabs or elements 320 that facilitate navigation between the user and the users one or more teams or leagues. In this example, the user participates in fantasy sports leagues on espn.com 321, sportingnews.com 322, CBSsportsline.com 324, and yahoo.com 326. In the displayed state, the page presents to the user information 330 associated with the user's leagues on the sportingnews.com site 331 and the yahoo.com site 332. Via the displayed information 331 or 332, the user may submit requests to access, manage, or otherwise manipulate or play the fantasy games associated with the respective sites.

For example, the user may provide input via the drop down menu 333 to set the player “Marc Bulger” as active, bench, or another status (e.g., a “starter” in the game for the week, or a “bench” player for the week). The system may then communicate with the site that hosts the game (sportingnews.com) and the player's team that includes Marc Bulger, and make any necessary changes at the site based on the received input. In some cases, the user may provide input to select a player in order to view content about the player, such as by clicking on the player's name 334. In this example, user selection of S. Alexander may cause the system to present a player page associated with S. Alexander that includes information and other content about the player, as discussed herein. In addition, the page 300 may include other information, such as advertisements 340, which may be associated or related to the user selections.

The presented advertisements may relate to or be associated with the player shown in the page 300. Following the above example, clicking on S. Alexander may lead to the system displaying advertisements sponsored by online vendors that sell jerseys associated with S. Alexander or online vendors that sell tickets to sporting events that include S. Alexander. In addition, the system may display advertising associated with the team a player is on, the city in which the player plays, the college the player attended, and so on.

Of course, the page 300 may present other information, such as user information, branding information, and so on, and may do so via the page 300 or via other screen elements.

In addition to the details described above, the intermediate site (or a site hosting a fantasy sports league) may perform additional functions and present other displays in order to enhance the user's experience. The system, in some cases, is a database driven, web-based community networking site that enables interactions between fantasy sports owners that are not in direct competition with one another, but may have common interests, such as common ownership of a player. The system may automatically extract some or all of an owner's fantasy sports player information and match the information with the information provided by other owners under management by the site

In some cases, the fantasy sports owner simply creates a system profile and the site extracts the required data from the owner's existing fantasy sports leagues, such as from integrated online providers. These owners may then view opinions and information associated with the players they own, because the system uses the information provided by the owner to parse all the information within the site in order to extract information of relevance to the owner.

In addition, owners may create custom profiles, rate other owners, rate other owner created content, generate content such as forecasts related to future performances by players, create content such as player comments, remarks, and so on. The system may then aggregate such data and generate performance ratings for owners. The system may also supplement owner provided information with information from leading fantasy sports discussion forums and news providers. The system may include search components that retrieve information from other sources via the web and presents the information to the owners. For example, the system may set up RSS feeds or other directly connected information sources for an owner, targeted to the owner's players.

Additionally, the site may provide information (such as content created within the site) to other sources. The site may transmit comments created within the site by users of the site to outside content sources, such as sports news sources. The transmitted comments may be targeted to news sources based on related or common interests or readership. For example, comments created within the site associated with Washington Redskins' players may be sent to or scraped by an online news source based in Washington, D.C. The system may choose the content to be transmitted based on a variety of factors, such as rankings of commentators, relevance, outside news source content, and so on.

Thus, in some examples, the system includes an intermediate site that facilitates user access to multiple leagues across multiple sites via a single, common interface, and enables users to request and receive targeted and user specific content related to the players they own in their leagues. Additionally, the intermediate site can act as an information management system that receives, ranks, and distributes content to users within the site, or users outside the site (via other sites). Through the intermediate site, the system provides users with content and information they could not receive when directly accessing their leagues at the fantasy sports management sites, because the intermediate site can aggregate information from owners using multiple sites to play fantasy sports, providing the owners with access to information from many different sites via a single interface.

### Using Messaging to Facilitate Roster Moves

As described above, the intermediate site enables a user to perform actions and receive content not provided by sites hosting the user's leagues. In some examples, the system performs roster moves upon receiving a message from a user, such as a text message from a mobile device associated with the user. In some cases, the system receives a message via the intermediate site, which causes the intermediate site to access the site hosting the user's league and perform an action related to a request within the received message. Of course, the system, in some cases, may bypass an intermediate site and receive the message directly at the site hosting the user's league and perform similar actions (in these cases the host site facilitates the reception of messages). The message may include information about the move, or may be sent to a certain address, upon which the system performs an action upon receipt of the message.

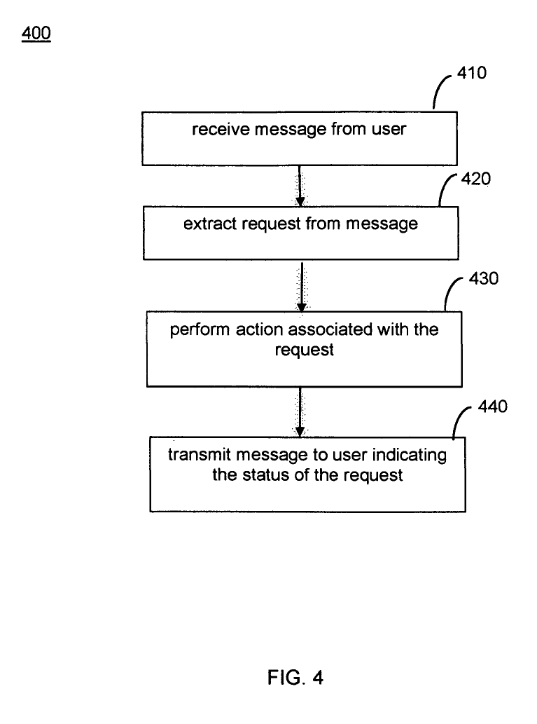

Referring to FIG. 4, a flow diagram illustrating a routine 400 for updating a user's fantasy sports team using messages is shown. In step 410, the system receives a message from a user indicating a request to make a roster move within a league associated with the user. For example, the system, via the intermediate site, receives a text message from a user that includes a request within the body of the message. The request may include the action to be performed and the player (or players) associated with the action to be performed. Actions to be performed may include starting a player, benching a player, picking up a player, dropping a player, initiating a trade for a player, tracking a player, obtaining information about a player, another owner, an ongoing game, and so on. The following are examples of messages that may be received by the system:
START Chad Pennington, BENCH Steve McNair
PICK UP Joey Galloway
TRADE David Wright

Of course, the system may utilize other message syntaxes or forms. For example, a user may simply send a player's name, and the system may infer from the message that the user wishes to place the player in a starting role. In addition, the intermediate site or the user may implement or determine the form or syntax of messages, such as how requests are formed or linked to specific actions to be performed. In some cases, a user may determine the words or phrases that relate to certain actions performed by the site. For example, the system may facilitate user entry of terms that, when received by the system, instruct the system to perform an action.

In addition to text messages, the system may receive SMS messages, USSD messages, voice messages, instant messages, email messages, and so on via a user's mobile device. The system may provide users with a unique address in which to send messages, or may provide one or more common addresses that receive all messages sent to the site related to roster moves. In these cases, the system may use the message's header information (such as the user's mobile address, phone number, or other unique identifier) or other information in order to identify the source of the message.

In step 420, the system extracts the request from the received message. For example, the system receives a text message from a user that includes the content “start Brandon Roy,” and determines that the user is requesting the system change the current roster to include Brandon Roy as a starter. In step 430, the system performs the action associated with the request. For example, upon receiving the request in step 420, the system accesses the site hosting the user's league and causes the site to move Brandon Roy to a starting position within the roster. Without additional instructions, the system may cause the site to move a player out of a starting position in order to satisfy the league's roster rules. The system may follow one or more rules in order to satisfy the league's roster rules, such as moving players not scheduled in real-life games that day, moving players that score comparatively fewer points, and so on.

In addition, a single message may include multiple instructions and/or requests related to more than one player owned or managed by the user. Also, a request may be applicable to some or all of the user's teams that contain the player in the message. For example, should the user manage two teams that have Chad Pennington, the system may receive the message “start Chad Pennington” and perform actions to move Chad Pennington into a starting role on both user teams.

In step 440, upon performing the action, the system may transmit a message to the user indicating the status of the request. For example, the system may receive confirmation from the site indicating Brandon Roy has been placed in a starting position, and transmit a message to the user indicating the new status.

Providing users the ability to initiate roster moves without directly accessing a host site or the intermediate site may enable users to easily and quickly perform roster moves when they would normally be unavailable to do so. For example, a user may be watching a sporting event at a bar and way from his/her computer, and notice a certain player or performance during the event. The user may want to add the player to his/her fantasy team, but other users at their computers may try and add the player before the user is able to get to a computer to make the roster move. However, the system can provide the user with such an opportunity without having to leave the bar. For example, the user may transmit a text message to the intermediate site he/she uses to access his fantasy leagues. The message may include “ADD Juan Pierre to Scorpions, DROP Maddux.” The intermediate site receives the message, determines the user wishes to pick up Juan Pierre in the league that contains the user's team named the Scorpions and drop Greg Maddux, and causes the site hosting the league to perform the requested actions. Once performed, the intermediate site sends a message back to the user confirming the pickup, such as “Juan Pierre is now a member of the Scorpions.”

### Player Pages

As described above, the intermediate site may provide content to users extracted from many different hosting sites, information sites, owners, and so on. In some examples, the intermediate site provides the content to users via a page associated with one or more players of interest to or owned by the user (that is, representations of players under management by the user). For example, the system may present a unique or specific page for a player to users that have an interest in or own the player, or may present the same player page to all users. In some cases, the system may receive input from users, and present information on the player page based on the user input, such as selections on what content they wish to view on the page, what statistics they wish to view, the formatting or placement of elements on the page, and so on.

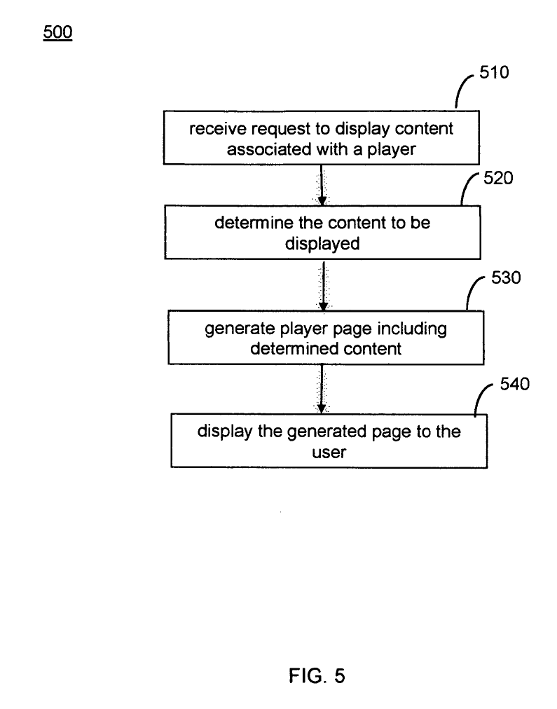

Referring to FIG. 5, a flow diagram illustrating a routine 500 for generating a player page associated with a representation of a player within a fantasy sports league is shown. In step 510, the system receives a request to display content associated with a player, such as a player page. The system may receive the request via user input, such as when a user clicks on a player associated with a team managed by the user, moves a cursor over the player's name, receives a user selection of a player via a page presenting all players under a certain category, and so on. In step 520, the system determines content to be displayed to the user, such as the content discussed herein. For example, the system may look to a data structure, such as a table or index, that associates the selected player with content, such as content supplied by other users. The system may also determine the content to be displayed based on input received from the user. For example, the user may set global parameters for all displayed content, or may set parameters specific to the selected player.

Upon determining the user owns or is interested in the selected player, the system, in step 530, generates a player page that includes content associated with the selected player and/or requested or selected by the user. Examples of unique content may include comments from other users that own the player in other leagues, contact information for other users that own or are interested in the player, user defined information, links to player specific message boards, links to player specific chat rooms, expert comments only provided to owners of the player, and so on. For example, the system may generate a page tailored to the user based on received input from the user. In step 540, the system displays the generated page to the user.

As described above, the system may provide unique content via a player page to users that own or are interested in the player, or based on input received by users that seek to customize the information they choose to view via the player page. For example, the unique player page may include comments provided by other users that own the player and may rank the comments according to ratings associated with the users. The player page may display comments provided only by other users that own the player, or may integrate the comments with comments from other users. In addition, the player page may display interface elements that facilitate networking between users that own the players. For example, the player page may display links to message boards dedicated to the player, chat rooms dedicated to the player, and/or buttons that facilitate direct communications between users (such as instant messaging, email messaging, and so on).

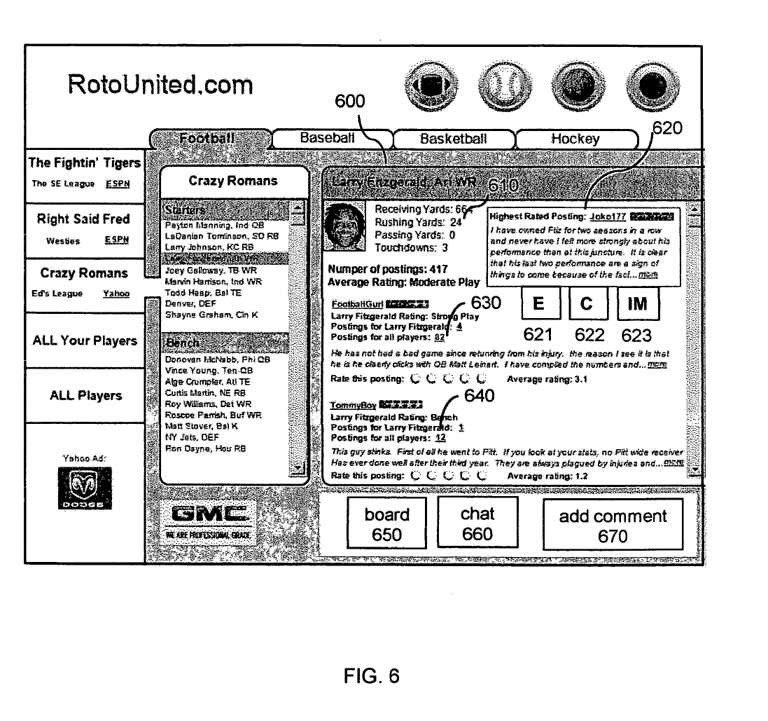

Referring to FIG. 6, a display illustrating an example unique player page 600 in a fantasy sports environment is shown. The player page 600 includes content available to all users as well as content provided to users based on user input. In this example, the system presents performance information 610 and user comments 630 and 640 to all users within the community, and presents an additional comment 620 based on input indicating a user request to receive information from the commentator that created the comment 620.

Additionally, the player page 600 includes elements that can be selected by a user to facilitate networking between users that share an interest in the player. For example, the page may present display buttons 621, 622, and 623 to enable a user to email, initiate a chat room session, or send an instant message, respectively, to the user that provided the comment 620 that was only displayed to other users that own or share an interest in the player. The player page includes other display elements used to facilitate interactions between owners. For example, a user may select display element 650 in order to enter a message board dedicated to the player, may select display element 660 to enter a chat room dedicated to the player, or may select element 670 to enter a comment to be displayed on the player page. Of course, the player page may include other elements and perform other functions. Thus, in some cases, the system facilitates interaction between users based on a shared interest in a player, among other benefits.

### Providing Information Based on Verified Possession of an Item

In addition to the fantasy sports environment, other online sites and environments may utilize some or all aspects of the above described system, such as aspects that facilitate the tracking of ownership in order to provide specialized or more reliable information to users. For example, aspects of the system may enable an online retailer that distributes, sells, auctions, rents, or otherwise provides goods, products and services to users to provide information to users of the retailer's site that is reliable and trustworthy, because the system verifies the information is provided by users that are associated with the good or service.

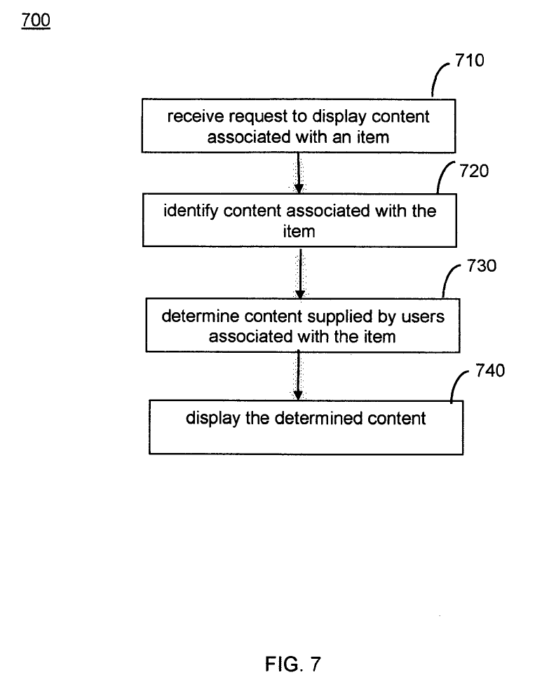

Referring to FIG. 7, a flow diagram illustrating a routine 700 for displaying content about a good or service to a user is shown. In step 710, a site providing a good or service receives a request to display information about an item. The request may be via input received from a user via a display page, such as a user clicking on the name of the item. In step 720, the system identifies content to be presented to the user. For example, the system may review a data structure, such as a table or index, that stores user provided content for the item. In step 730, the system determines content provided by users associated with the item. For example, the system may review user information and determine the user purchased or rented the item via the site. In step 740, the system displays the determined content provided by users associated with the item. For example, the system may display only content from user the system verified as owners or renters, or may display such content with certain indicia that indicate to other users that the content was provided by users that own or rented the item.

The following examples describe some environments in which sites may provide information from users verified to be owners or renters or may facilitate networking and other communications between users that commonly own, rent or lease a common good or service.

An online book merchant may facilitate an online book club for users that purchase the same book. Because the merchant contains information that other members in the book club have purchased the book, it may provide a user with a more reliable user experience (the retailer, having sold the book to the members, is able to verify that all members own the book).

A travel services site that provides and sells travel, such as flights, hotel rentals, car rentals, and so on, may provide more reliable information to users. Currently, similar sites allow any users to comment and provide information on aspects of travel, such as on a hotel's service, an experience in a destination of a flight, and so on. Although this information may be useful, users may also find the information unreliable, as a user may not know the source of the information (generally, comments come from other users identified by a login name or nickname). For example, a hotel owner may provide positive comments about their hotel in order to sway users to come to the hotel. Using the system described herein, the travel services site may restrict comments about a specific travel service (such as a hotel) to users that have rented rooms in the hotel via the site. Thus, other users may feel a level comfort that any information provided about the hotel is (somewhat) reliable.

A financial institution that trades stocks and other monetary commodities may enable users sharing stocks to interact with one another. The institution, via an associated site, may enable users that share a stock to communicate with one another. The interaction may be indirect (e.g., user provided stock tips or information about the stock are shared with other owners) or direct (e.g., the site may facilitate communications between users sharing a given stock).

Thus, the system may facilitate communications between users that own, share, possess, or have an interest in a certain commodity or representation of a commodity in a variety of online environments. Of course, other environments not described herein may employ aspects of the system.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the technology can be modified, if necessary, to employ the systems, functions, and concepts of the various references described above to provide yet further embodiments of the technology.

These and other changes can be made to the invention in light of the above Detailed Description. While the above description describes certain embodiments of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated.

We claim:

1. A method in a computing system for presenting information about a player associated with a fantasy sports league, the method comprising:
receiving a selection from a user of a representation of a player within a fantasy sports environment, wherein the representation of the player is associated with a real-life player within a real-life sports league tracked by the fantasy sports environment;
determining content to be presented to the user, wherein the content is related to the player and includes information provided by at least one user within the fantasy sports environment;
generating a web page that includes the determined content; and
presenting the generated web page to the user.

2. The method of claim 1, wherein the generated web page is presented to the user via an online site that hosts the fantasy sports league.

3. The method of claim 1, wherein the selection is received via an intermediate site associated with the user.

4. The method of claim 1, wherein the content of the generated web page is selected at least in part by the user.

5. The method of claim 1, wherein a format of the generated web page is selected at least in part by the user.

6. The method of claim 1, wherein the generated web page includes a display element that facilitates a connection to a message board associated with the representation of the player.

7. The method of claim 1, wherein the generated web page includes a display element that facilitates a connection to a chat room associated with the representation of the player.

8. The method of claim 1, wherein the generated web page includes a display element that facilitates a connection between the user and another user that owns the representation of the player.

9. A system for presenting information associated with two or more fantasy sports teams managed by a user, the system comprising:
an aggregation component, wherein the aggregation component is configured to retrieve information associated with fantasy sports teams managed by a user and present the aggregated information to the user via a display component;
a player content component, wherein the player content component is configured to retrieve content associated with players on the fantasy sports teams managed by the user for presentation to the user; and
a page generation component; wherein the page generation component is configured to generate player pages associated with the players on the fantasy sports teams managed by the user that present the retrieved content, wherein at least one generated player page includes content selected by the user.

10. The system of claim 9, further comprising:
an advertisement component, wherein the advertisement component is configured to display advertisements based on the content presented by the player pages.

11. The system of claim 9, wherein at least one generated player page includes content only available to users that manage a fantasy sports team that includes the player associated with the generated player page.

12. The system of claim 9, wherein the display component presents the generated player pages to the user.

13. A computer-readable medium whose contents cause a computing system to perform a method for providing information about a good or service to a user, the method comprising:
causing a display device associated with a user to present a user interface including a display of one or more goods or services available for purchase by the user;
receiving a selection of a good or service from a user, wherein the selection indicates a request for information about the selected good or service; and
retrieving information associated with the selected good or service, wherein the retrieved information includes information provided by other users that purchased the good or service; and
presenting the retrieved information to the user via the user interface, wherein the presented information distinguishes the information provided by other users that purchased the good or service.

14. The computer-readable medium of claim 13, wherein retrieving information includes verifying that the users providing information purchased the good or service.

15. The computer-readable medium of claim 13, wherein distinguishing the information includes presenting the information in a manner different than other information.
